(19) United States
(12) Patent Application Publication
(10) Pub. No.: US 2011/0001074 A1
(43) Pub. Date: Jan. 6, 2011

(54) METERING SOLENOID VALVE

(76) Inventor: Paul G. Szymaszek, Necedah, WI (US)

Correspondence Address: PARKER-HANNIFIN CORPORATION;HUNTER MOLNAR BAKER MORGAN, 6035 PARKLAND BOULEVARD, CLEVELAND, OH, 44124-4141, US

(21) Appl. No.: 12/921,574

(22) PCT Filed: May 20, 2009
(86) PCT No.: PCT/US2009/044618

§ 371 Date: Sep. 9, 2010

Related U.S. Application Data
(60) Provisional application No. 61/054,497, filed on May 20, 2008.

(51) Int. Cl. F16K 31/02

(52) U.S. Cl. 251/129.15

(57) ABSTRACT

A metering solenoid valve is provided for refrigeration applications, wherein the metering solenoid valve combines the function and characteristics of a solenoid valve and a hand expansion valve into a single valve. The valve includes an adjustable stem housing allowing the flow of the valve to be adjusted.

### CROSS-REFERENCE TO RELATED CASES

This application claims the benefit of U.S. Provisional Application Ser. No. 61/054,497; filed May 20, 2008, the disclosure of which is expressly incorporated herein by reference.

### TECHNICAL FIELD

The present invention relates, in general, to a metering solenoid valve such as the type used in refrigeration applications, and in particular to a valve that combines a solenoid valve and hand expansion valve into a single valve.

### BACKGROUND

A prior art heavy duty solenoid valve 110 is shown in FIG. 1 as a pilot operated, semi-steel bodied valve suitable for Ammonia, R-12, R-22, and R-502, other refrigerants, certain oils and other fluids approved for use in refrigeration. The valve may be opened by means of the manual opening stem 112 for servicing or in case of electrical power failure (shown covered by cap 113). The valve is a pilot operated solenoid shown in FIG. 1 in its closed position, with the solenoid coil 114 de-energized and the plunger needle 116 and main port plug 118 in the seated position. Electrical energization of the solenoid coil 114 forms a magnetic field, pulling up the plunger which strikes the needle 116, lifting it off its seat 117. Upward motion of the needle 116 permits entrance of the fluid from the valve inlet 120 through the pilot port 124 to the top of the power piston 126. This forces the piston 126 downward and pushes the main port plug 118 open, thereby permitting flow of the refrigerant through the main valve port 188 to the outlet 121. The closing spring meanwhile is held in a compressed position. De-energization of the solenoid coil 114 permits the spring-assisted needle 116 to drop back into its seat 117, stopping the flow through the pilot port 124. Bleed-off, through the bleed hole 128 in the piston 126, decreases the pressure above the piston 126 and allows the closing spring 130 to force the main port plug 118 upward into a closed position to stop the flow. The pressure difference across the valve 110, acting upon the area of the valve seat, plus the force of the closing spring 130, holds the main port plug in a tightly closed position.

The solenoid valves 110 typically require a hand expansion valve to be used in conjunction with the solenoid valve in order to meter the flow of the refrigerant. Referring to FIG. 2, a hand expansion valve 210 is shown having a tapered plug 218 for providing throttling action.

### SUMMARY

At least one embodiment of the invention provides a valve assembly comprising: a housing having a valve inlet and a valve outlet; a through port between an inlet fluid passageway and an outlet fluid passageway; a solenoid valve; a piston positioned between the outlet fluid passageway of the inlet and the solenoid valve; a by-pass port extending from the inlet to the solenoid valve; a plug biased against the port and movable between a closed position and a fully retracted position providing an annular opening through the port, a portion of the plug extending beyond the port and terminating at a distal end of the plug, the plug portion having an axial cross-section that gradually decreases toward a distal end of the plug; a manual opening stem engaging the plug and adapted to retract the plug from the port and provide an opening through the port.

At least one embodiment of the invention provides a solenoid valve assembly comprising: a housing having a valve inlet and a valve outlet; a through port between an inlet fluid passageway and an outlet fluid passageway; a stem housing adjustably attached to the housing; a plug formed generally in a frustoconical shape biased against the port and movable to provide an annular opening through the port, the plug shape and position preventing full flow through the port; a manual opening stem engaging the plug and adapted to retract the plug from the port and provide an opening through the port.

### BRIEF DESCRIPTION OF THE DRAWINGS

Embodiments of this invention will now be described in further detail with reference to the accompanying drawings, in which:

FIG. 1 is a cross-sectional view of a prior art solenoid valve;

FIG. 2 is a cross-sectional view of a prior art hand expansion valve;

FIG. 3 is a perspective, cross-sectional view of an embodiment of the metering solenoid valve in accordance with the present invention;

FIG. 4 is a cross-sectional view of an embodiment of the metering solenoid valve in accordance with the present invention in a closed position; and

FIG. 5 is a cross-sectional view of an embodiment of the metering solenoid valve in accordance with the present invention in an open position.

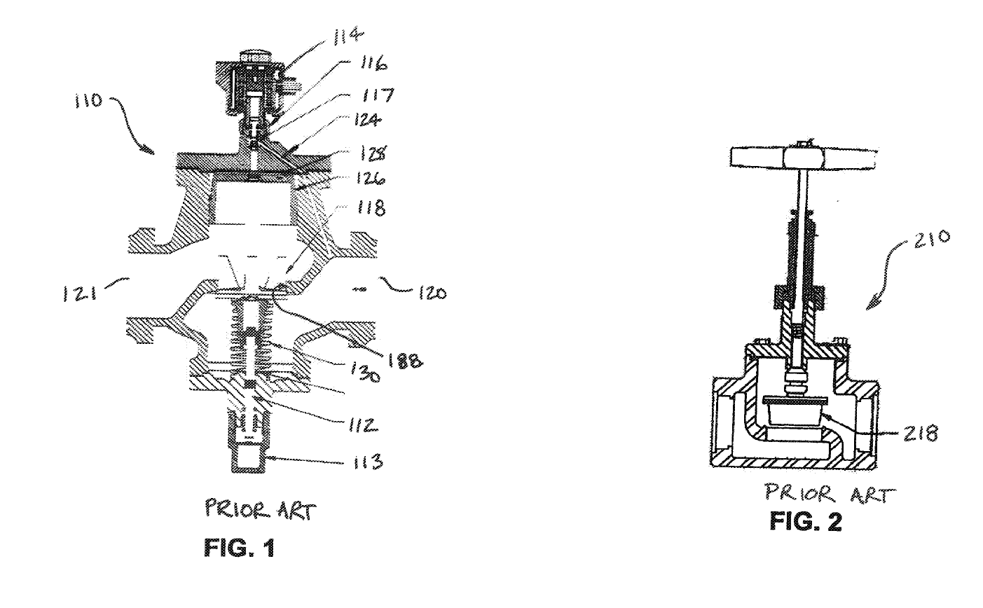

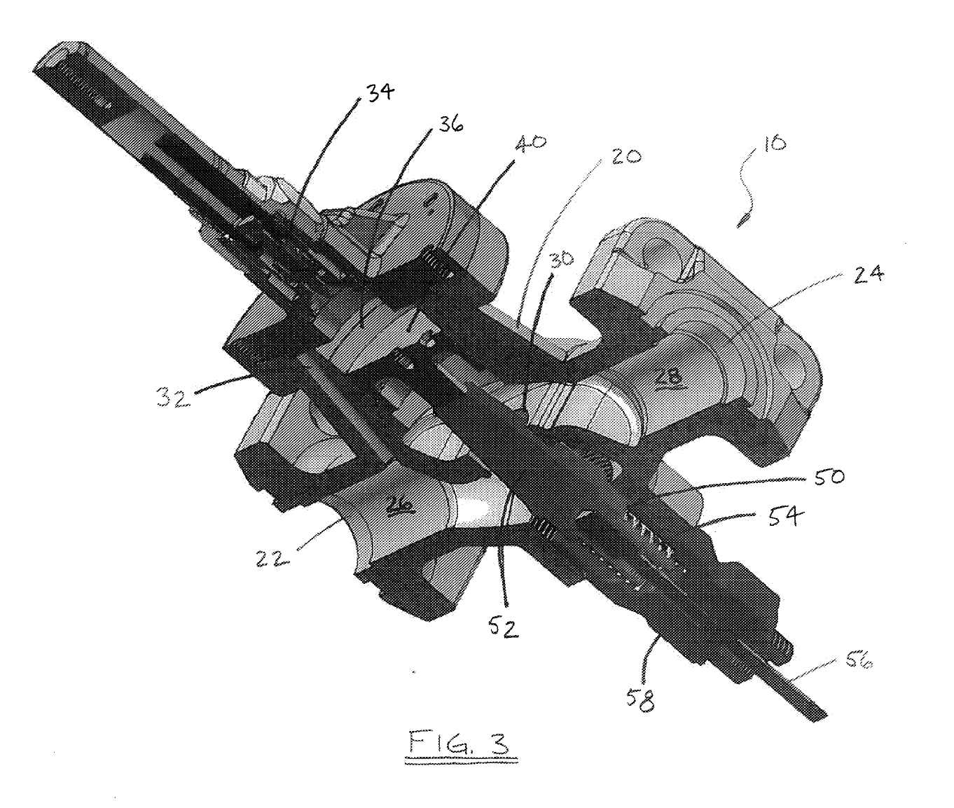

### DETAILED DESCRIPTION

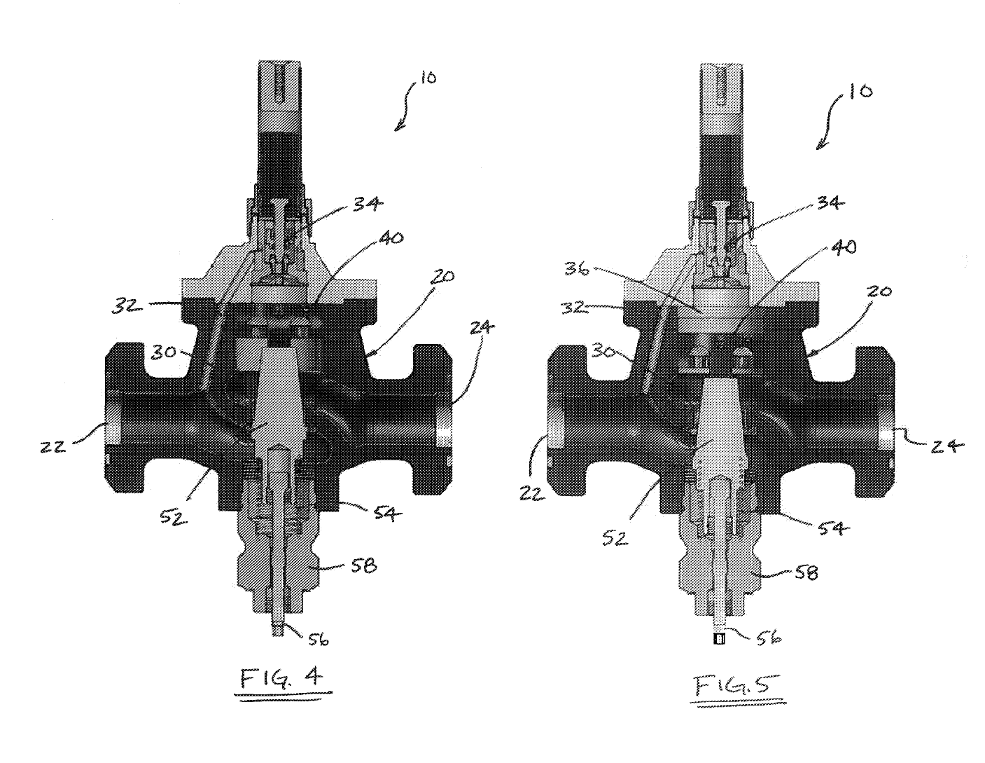

An embodiment of the present invention is shown in FIG. 3 as a metering solenoid valve assembly 10 in a perspective cross-sectional view and for additional clarity, in FIG. 4 as a cross-sectional view in a closed position and in FIG. 5 as a cross-sectional view in an open position. The valve assembly 10 comprises a housing 20 having an inlet 22, an outlet 24, an inlet passageway 26, an outlet passageway 28 and a through port 30 providing a fluid passageway between the inlet passageway 26 and the outlet passageway 28. As with the prior art solenoid valve, the inlet passageway 26 includes a by-pass port 32 which extends to a solenoid 34 which when energized allows fluid to flow to a chamber 36 above a piston 40. The valve assembly 10 also includes a metering/manual open plug assembly 50 comprising a plug 52, a closing spring 54, a manual opening stem 56, and an adjustable stem housing 58. The metering/manual open plug assembly 50 combines the functionality of the manual open plug of the solenoid valve and the metering function of the hand expansion valve. In operation, the fluid entering chamber 36 forces piston 40 into the housing 20. The piston engages the plug 52 which moves against the force of the closing spring 54 and opens the through port 30. The plug 52 is limited in the distance that it is able to move. The end of the plug 52 engages a stop surface of the stem housing 58. The stem housing 58 is adjustably positioned by threadably setting the depth of the step housing 58 into housing 20, allowing the amount of flow through the port 30 to be adjusted due to the geometrical shape of the plug 52. It is noted that the plug 52 shown is tapered in a generally frustoconical shape that extends a distance through the port 30 such that even when the port 30 is open, the plug 52 does not allow full flow through the port 30 and that an annular opening is formed. It is contemplated that other plug shapes could also be used that have a changing cross-sectional dimension along its axial length.

The valve 10 may be opened by means of the manual opening stem 56 for servicing or in case of electrical power failure. The manual opening stem 56 has a head portion 57 which is coupled to the plug 52. The stem 56 is threadably engaged by the stem housing 58 such that the valve 10 can be opened by rotating the stem 56. The stem 56 retracts the plug 52 against the spring force to open the port 30

The combination of the solenoid valve and the metering valve into a single valve can save in manufacturing costs, inventories, additional welds for two components, etc.

Although the principles, embodiments and operation of the present invention have been described in detail herein, this is not to be construed as being limited to the particular illustrative forms disclosed. They will thus become apparent to those skilled in the art that various modifications of the embodiments herein can be made without departing from the spirit or scope of the invention.

1. A valve assembly comprising:
a housing having a valve inlet and a valve outlet;
a through port between an inlet fluid passageway and an outlet fluid passageway;
a solenoid valve;
a piston positioned between the outlet fluid passageway of the inlet and the solenoid valve;
a by-pass port extending from the inlet to the solenoid valve;
a plug biased against the port and movable between a closed position and a fully retracted position providing an annular opening through the port, a portion of the plug extending beyond the port and terminating at a distal end of the plug, the plug portion having an axial cross-section that gradually decreases toward a distal end of the plug;
a manual opening stem engaging the plug and adapted to retract the plug from the port and provide an opening through the port.

2. The valve of claim 1, wherein the plug portion has a generally frustoconical shape.

3. The valve of claim 1, wherein the distal end of the plug engages a portion of the piston positioned between the outlet fluid passageway of the inlet and the solenoid valve.

4. The valve of claim 1, wherein a portion of the plug is positioned in the throughput when the plug in a fully retracted position.

5. The valve of claim 1, wherein the piston has a bleed hole fluidly connecting the outlet fluid passageway to a piston cylinder volume above the piston.

6. The valve of claim 1 further comprising a stem housing adjustably attached to the housing, the stem housing adjustably positioned by threadably setting the depth of the step housing into housing, allowing the amount of flow through the port to be adjusted due to the geometrical shape of the plug.

7. A solenoid valve assembly comprising:
a housing having a valve inlet and a valve outlet;
a through port between an inlet fluid passageway and an outlet fluid passageway;
a stem housing adjustably attached to the housing;
a plug formed generally in a frustoconical shape biased against the port and movable to provide an annular opening through the port, the plug shape and position preventing full flow through the port;
a manual opening stem engaging the plug and adapted to retract the plug from the port and provide an opening through the port.

8. The valve of claim 1, wherein a distal end of the plug opposite the stem housing engages a portion of the piston positioned between the outlet fluid passageway of the inlet and the solenoid valve.

9. The valve of claim 1, wherein the piston has a bleed hole fluidly connecting the outlet fluid passageway to a piston cylinder chamber above the piston.

10. The valve of claim 7, wherein the stem housing is adjustably positioned by threadably setting the depth of the step housing into housing, allowing the amount of flow through the port to be adjusted due to the frustoconical shape of the plug.
